(19) United States
(12) Patent Application Publication
(10) Pub. No.: US 2019/0352431 A1
(43) Pub. Date: Nov. 21, 2019

(54) Method for Production of Bioplastics from Lignocellulosic Materials

(71) Applicant: Lakehead University, Thunder Bay (CA)

(72) Inventors: Lew P. Christopher, Thunder Bay (CA); MD Nur Alam, Thunder Bay (CA)

(21) Appl. No.: 16/415,589

(22) Filed: May 17, 2019

Related U.S. Application Data
(60) Provisional application No. 62/673,282, filed on May 18, 2018.

(51) Int. Cl. C08B 15/04; C08B 15/10

(52) U.S. Cl. CPC C08B 15/04; C08B 15/10

(57) ABSTRACT

We have developed a new method to prepare bioplastic materials for a number of potential green applications. The bioplastics have superior tensile strength to their synthetic counterparts. The method involves the use of three known chemical reactions: 1) periodate oxidation to prepare 2,3-dialdehyde cellulose pulp (DACP), 2) chlorite oxidation to prepare 2,3-dicarboxyl cellulose pulp (DCCP) from DACP, and 3) crosslinking DCCP with a suitable amine-containing crosslinking agent.

### PRIOR APPLICATION INFORMATION

The instant application claims the benefit of U.S. Provisional Patent Application 62/673,282, filed May 18, 2019 and entitled “Method for Production of Bioplastics from Lignocellulosic Materials”, the contents of which are incorporated herein by reference.

### BACKGROUND OF THE INVENTION

Synthetic polymers such as polyethylene (PE), polypropylene (PP) and polyethylene terephthalate (PET) and metals (aluminum) are commonly used in high-barrier applications, food packaging in particular. From a Bioeconomy perspective, it will be advantageous and beneficial to replace synthetic and metal packaging with biomaterials (bioplastics) such as natural cellulose fibers due to their green features (sustainable/renewable, biodegradable, environmentally friendly). For instance, the global market for flexible packaging materials is steadily expanding due to population growth and urbanization. In 2015, this market was USD 260 billion which is projected to grow to USD 320 billion by 2020.

### SUMMARY OF THE INVENTION

According to an aspect of the invention, there is provided a method for preparing 2,3-dialdehyde cellulose pulp (DACP) comprising:

mixing bleached softwood pulp, sodium metaperiodate and sodium chlorite in water for a period of time, thereby producing 2,3-dialdehyde cellulose pulp (DACP).

According to another aspect of the invention, there is provided a method for producing 2,3-dicarboxyl cellulose pulp (DCCP) comprising:

mixing 2,3-dialdehyde cellulose pulp, sodium chlorite and hydrogen peroxide in water having a pH of 5 or below for a period of time, thereby producing DCCP.

According to a further aspect of the invention, there is provided a method for producing 2,3-dicarboxyl cellulose pulp (DCCP) for preparing bioplastic material comprising:

mixing bleached softwood pulp, sodium metaperiodate and sodium chlorite in water for a period of time, thereby producing 2,3-dialdehyde cellulose pulp (DACP); and

mixing the 2,3-dialdehyde cellulose pulp with sodium chlorite and hydrogen peroxide in water having a pH of 5 or below for a period of time, thereby producing DCCP.

According to another aspect of the invention, there is provided a method for preparing DCCP-crosslinked bioplastic material with enhanced strength comprising:

reacting DACP (2,3-dialdehyde cellulose) with a suitable amine-containing crosslinking agent, thereby providing a crosslinked bioplastic material with enhanced strength.

As will be appreciated by one of skill in the art, a wide variety of amine-containing crosslinking agents may be used within the invention, depending on the desired effects and functionalities that are imparted on DACP. For example, a suitable amine-containing crosslinking agent may be selected based on its molecular weight, solubility in water and/or reactivity. Suitable amine-containing crosslinking agents may include but are by no means limited to chitosan and alkyl di-amine.

### DESCRIPTION OF THE PREFERRED EMBODIMENTS

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described. All publications mentioned hereunder are incorporated herein by reference.

We have developed a new method to prepare bioplastic materials for a number of potential green applications, including biodegradable food packaging, flexible displays, cosmetics, pharmaceuticals, and the like. Due to their physical properties (superior to their synthetic counterparts and other bioplastic materials), our bioplastic materials can compete with commercial bio/polymers currently on the market such as PE, PP, PET and cellophane.

Specifically, a comparison of the tensile strength of the bioplastic material of the invention and common synthetic and bioplastic materials known in the art is provided in Table 1. As can be seen therein, the tensile strength of the bioplastic material of the invention is significantly greater than even cellophane and PET materials.

As will be appreciated by one of skill in the art, the bioplastics material of the invention has the added advantage of being biodegradable. As will be apparent to one of skill in the art, the rate at which the bioplastics material of the invention degrades will of course depend on the surrounding environment, for example, but by no means limited to the humidity, temperature, pH and airflow of the environment. Under standard conditions (using a standard enzymatic method), bioplastics completely degrade within 7-9 days with enzyme and within 30-45 days without enzyme.

The method of the invention involves the use of two and in some cases three known chemical reactions: 1) periodate oxidation to prepare 2,3-dialdehyde cellulose pulp (DACP) and 2) chlorite oxidation to prepare 2,3-dicarboxyl cellulose pulp (DCCP) from DACP, and 3) crosslinking DCCP with a suitable amine-containing crosslinking agent.

The chemistry of the first reaction (periodate oxidation) has been modified by using a novel reaction protocol that renders cellulose fibers uniformly charged throughout the fiber cell wall. As will be appreciated by one of skill in the art, if the cellulose fibers are not uniformly charged, the bioplastics produced may have a lower strength, as the cellulose fibers will be in different forms at the micro, nano and molecular level. This in turn offers outstanding (improved) bioplastic properties such as tensile strength, density, water and oxygen permeability that altogether extend the versatility of our bioplastic materials for potential applications in various industry sectors. In addition, the overall process invented here is carried out in aqueous medium (water) and is therefore greener than current methods for production of other bioplastic materials such as cellophane and polyhydroxybutyrate (PHB) that require use of organic solvents which are of environmental concern for their processing and preparation

The main features of our new bioplastics are:
Stronger than other commercially available synthetic and bioplastic materials (see Table 1)
Biodegradable
Utilize softwood and hardwood, kraft and sulfite pulps as raw material
Expand uses and markets for lignocellulosic materials into food packaging, flexible displays, cosmetics, pharmaceuticals, and the like.
The bioplastic films prepared for packaging applications are highly transparent, flexible and bendable.

According to an aspect of the invention, there is provided a method for preparing 2,3-dialdehyde cellulose pulp comprising:

mixing bleached softwood pulp, sodium metaperiodate and sodium chlorite in water for a period of time, thereby producing 2,3-dialdehyde cellulose pulp (DACP).

In some embodiments of the invention, the mixing is carried out under low light conditions and/or in the dark.

The sodium metaperiodate may be added to the softwood pulp at about 50-100 mol % periodate per mole of anhydrous glucose unit (AGU).

The period of time may be from 0 to 7 days.

The mixing may be carried out at a temperature between about 15 C to 60 C or from about 20 C to 60 C.

In some embodiments, the produced DACP was filtered and washed with water.

In some embodiments, the mixture is:

2.5-5% bleached softwood pulp (w/v or w/100 ml water),

1.5-3% sodium metaperiodate (w/v or w/100 ml water); and

2-5% sodium chlorite (w/v or w/100 ml).

According to another aspect of the invention, there is provided a method for producing 2,3-dicarboxyl cellulose pulp (DCCP) comprising:

mixing 2,3-dialdehyde cellulose pulp, sodium chlorite and hydrogen peroxide in water having a pH of 5 or below for a period of time, thereby producing DCCP.

As will be apparent to one of skill in the art, at above pH 5, aldehyde groups are not reactive, and would not convert to carboxylic groups. In preferred embodiments, the pH is 4-5 or 4.5-5.0.

In some embodiments of the invention, the pH is maintained at below 5 by addition of a base.

In some embodiments of the invention, the produced DCCP was precipitated by addition of ethanol.

In some embodiments, the precipitated DCCP is filtered and washed with acetone.

The period of time may be from 0 to 7 days.

The mixing may be carried out at a temperature between about 15 C to 60 C or from about 20 C to 60 C.

In some embodiments of the invention, the mixture is:

2-5% DACP (w/v or g/100 ml water);

0.5-1.5% sodium chlorite (w/v or g/100 ml water); and

0.5-1.5% of a 30% hydrogen peroxide solution (w/v or g/100 ml water).

According to another aspect of the invention, there is provided a method for producing 2,3-dicarboxyl cellulose pulp (DCCP) comprising:

mixing bleached softwood pulp, sodium metaperiodate and sodium chlorite in water for a period of time, thereby producing 2,3-dialdehyde cellulose pulp (DACP); and

mixing the 2,3-dialdehyde cellulose pulp with sodium chlorite and hydrogen peroxide in water having a pH of 5 or below for a period of time, thereby producing DCCP.

In some embodiments of the invention, the production of DACP is carried out under low light conditions and/or in the dark.

The sodium metaperiodate may be added to the softwood pulp at about 50-100 mol % periodate per mole of anhydrous glucose unit (AGU).

The minimum reaction time is 3 hours.

The reactions may be carried out at a temperature between about 15 C to 60 C or from about 20 C to 60 C respectively.

In some embodiments, the produced DACP was filtered and washed with water prior to use in the second reaction.

In some embodiments, the first reaction mixture is:

2.5-5% bleached softwood pulp (w/v or w/100 ml water),

1.5-3% sodium metaperiodate (w/v or w/100 ml water); and

2-5% sodium chlorite (w/v or w/100 ml).

In some embodiments of the invention, the pH of the second reaction is maintained at below 5 by addition of a base.

In some embodiments of the invention, the produced DCCP was precipitated by addition of ethanol.

In some embodiments, the precipitated DCCP is filtered and washed with acetone.

In some embodiments of the invention, the second reaction mixture is:

2-5% DACP (w/v or g/100 ml water);

0.5%-1.5% sodium chlorite (w/v or g/100 ml water); and

0.5%-1.5% of a 30% hydrogen peroxide solution (w/v or g/100 ml water).

In some embodiments of the invention, a suitable amine-containing crosslinking agent is used for a crosslinking reaction with DCCP.

In these embodiments, the amine-containing crosslinking agent is selected from a group of amine-containing crosslinking agents consisting of chitosan and/or alkyl di-amine.

In some embodiments, the amine-containing crosslinking agent is added to DCCP at 1-5 wt %.

Accordingly, the methods of the invention provide for the production of bioplastics from lignocellulosic materials that contain 1-4 mmol carboxylic groups per gram cellulose, preferably 1.2-1.5 mmol/g.

That is, in some embodiments, DCCP is further reacted with a suitable amine-containing crosslinking agent.

The amine-containing crosslinking agent may be selected from the group consisting of chitosan and alkyl-di-amine of different molecular weights.

The amine-containing crosslinking agent may be reacted with 2,3-dicarboxyl cellulose pulp (DCCP) at 15 to 60 C.

The amine-containing crosslinking agent may be reacted with DCCP for 0 to 2 hours or from 0.1 to 2 hours.

The DCCP-crosslinked bioplastic film may be hot-press dried at 15-100 C.

The DCCP-crosslinked bioplastic film may be hot-press dried for 0 to 2 hours or 0.1 to 2 hours.

The DCCP-crosslinked bioplastic film may be hot-press dried at 0-10 MPa.

The bioplastics materials of the invention have a tensile strength of 100-140 or 100-165 MPa, which is more than 3-fold higher than that of any commercially available synthetic oil-based plastic materials.

Furthermore, the tensile strength is more than 2.5-fold higher than that of prior art commercial bioplastic materials.

Finally, the bioplastics materials have a density of 1.3-1.5 g/cm³ which is similar to that of other commercial bioplaslics.

As discussed herein, the methods of the invention provide for production of bioplastics from both softwood and hardwood pulps, for example from both kraft and sulfite pulps.

As discussed herein, the methods are carried out in aqueous medium without the use of organic solvents and can be used for the production of non-transparent, semi-transparent and fully transparent bioplastic films for packaging and other applications

The invention will now be further explained and elucidated by way of examples; however, the invention is not necessarily limited to the examples.

### EXAMPLE 1-1

### Preparation of DACP

Periodate oxidation of lignocellulosic pulp was carried out in a glass beaker containing water (200 ml), bleached softwood kraft pulp (5 g dry weight}, sodium metaperiodate (3.3 g), and sodium chlorite (5.8 g). The reaction mixture was gently stirred at room temperature in the dark for 12 h. After the reaction, the modified pulp was filtered out and thoroughly washed with water. The aldehyde content of the cellulose was then calculated using the hydroxylamine-hydrochloride (NH₂OH.HCl) standard titration method, by which the HCl released from the reaction of aldehydes and NH₂OH.HCl is determined by titration with NaOH solution of known normality. The aldehyde content of DACP as prepared in this example was 1.2 mmol/g cellulose.

### EXAMPLE 1-2

### Preparation of DCCP

DACP (4.5 g dry weight), sodium chlorite (1.27 g, 80% purity) and hydrogen peroxide (1.27 g, 30% solution) were mixed with 200 ml water. The reaction mixture was let to react by stirring at room temperature for 12 h.

During the reaction, the pH was maintained at pH 5 by dropwise addition of NaOH (necessary during the first 3 h of reaction). Thereafter, 2 volumes of ethanol (400 ml) were added to the mixture to precipitate the reacted pulp (DCCP). The DCCP fibers were separated by filtration, washed with acetone twice, and dried. The carboxyl content of DCCP was 1.15 mmol/g cellulose, as determined by conductometric titration.

### EXAMPLE 2-1

### Preparation of OACP

As described in Example 1

### EXAMPLE 2-2

### Preparation of DCCP

As described in Examples 1 except that the reaction time which was 2 h. The carboxyl content of DCCP was 0.68 mmol/g cellulose.

As will be apparent to one of skill in the art, in Example 2, we reduced the reaction time in step 2 (chlorite oxidation). We expected (and determined) less carboxyl groups (almost half of example 1), with more unreacted aldehyde groups. The aldehyde groups participate in a crosslinking reaction upon drying and therefore produce stronger films. Hence, the strength of the bioplastics material depends on the amount of aldehyde groups, although the strength of the bioplastics material is not directly proportional to the amount of aldehyde groups.

### EXAMPLE 3-1

### Preparation of DACP

As described in Example 1 except that the reaction time which was 72 h. The aldehyde content of DACP as prepared in this example was 3.3 mmol/g cellulose.

### EXAMPLE 3-2

### Preparation of DCCP

As described in Example 1 except that the sodium chlorite (2.1 g, 80% purity) and hydrogen peroxide (2.1 g, 30% solution) were mixed with water. The carboxyl content of DCCP was 3 mmol/g cellulose.

In Example 3, both steps (periodate and chlorite oxidations) were changed. Specifically, as a result of these changes, we introduced more aldehyde groups (step 1) and then more carboxyl groups (step 2) in order to get a more transparent film.

Transparency depends on the amount of carboxylic groups (carboxylic group content). Strength depends on the remaining amount of aldehyde groups (aldehyde group content). The balance between the two determines the properties of the bioplastic material. Any change in that balance could result in a significant alteration of the bioplastic properties. This tool enables the design of bioplastic products for custom-tailored applications. For example, in food packaging, transparency of the material is highly desirable (more than strength). However, for cosmetic and pharmaceutical uses (e.g. cosmetic and pharmaceutical containers), strength is required whereas transparency may not be needed or desired.

### EXAMPLE 4

### Preparation of Bioplastic Film from DCCP

DCCP as prepared in Example 1 (1 g dry weight) was well dispersed in Milli-Q water by magnetic stirring to obtain a 1% (w/w) suspension. Fifteen (15) milliliters of suspension solution was poured into a Millipore vacuum filtration glass holder with a polyester membrane filter (pore size 0.2 μm, diameter 47 mm) and filtered to remove any free liquid. A bioplastic film with an approximate thickness of 30 μm and diameter of 25 mm was formed on the membrane. The film was peeled off of the membrane, dried first in an oven at 50° C. for 3-4 h, and then at 105° C. for 2 h. The tensile strength and density of the semi-transparent bioplastic film was 135 MPa and 1.38 g/cm³, respectively.

As will be appreciated by one of skill in the art, this demonstrates that the bioplastics material can be used to make products of a wide variety of shapes, not just biofilms, for example but by no means limited to bottles (round), cosmetic containers (square), medicine carriers (capsules) and the like.

### EXAMPLE 5

### Preparation of Bioplastic Film from DCCP

DCCP was prepared as described in Example 2. The bioplastic film prepared according to Example 4 was semi-transparent with tensile strength of 120 MPa and density of 1.40 g/cm³.

### EXAMPLE 6

### Preparation of Bioplastic Film from DCCP

DCCP was prepared as described in Example 3. The bioplastic film prepared according to Example 4 was transparent with tensile strength of 105 MPa and density of 1.50 g/cm³.

### EXAMPLE 7

### Preparation of DCCP-Crosslinked Bioplastic Film

DCCP-crosslinked bioplastic film was prepared by mixing DCCP (prepared as described in Example 5) with 1 wt % of chitosan followed by hot-press drying. The bioplastic film was semi-transparent with tensile strength of 160 MPa and density of 1.35 g/cm³.

### EXAMPLE 8

### Preparation of DCCP-Crosslinked Bioplastic Film

DCCP-crosslinked bioplastic film was prepared by mixing DCCP (prepared as as described in Example 5) with 1 wt % of octyl di-amine followed by hot-press drying. The bioplastic film was semi-transparent with tensile strength of 155 MPa and density of 1.30 g/cm³.

In Examples 4, 5, 7 and 8 semi-transparent film were produced; however, the film in example 5 was more hydrophobic than Example 4, due to the higher amount of aldehyde groups. In Example 6, a more transparent and higher density biofilm was produced due to the increase in the amount of carboxyl groups. In Examples 7 and 8, a semi-transparent film with enhanced strength was produced that is due to the use of a crosslinking agent and a hot-press drying process.

The scope of the claims should not be limited by the preferred embodiments set forth in the examples but should be given the broadest interpretation consistent with the description as a whole.

| Synthetic and bloplastic materials | Tensile strength (MPa) |
|---|---|
| Polyethylene {PE) - synthetic oil-based plastic | 20 |
| Polypropylene (PP} - synthetic oil-based plastic | 33 |
| Polyethylene terephthalate (PET) - synthetic | 41 |
| oil-based plastic | |
| Polyhydroxybutyrate (PHB) - bioplastic | 30-35 |
| Cellophane - bioplastic | 35-55 |
| Our bioplastic material | 100-165 |

1. A method for preparing 2,3-dialdehyde cellulose pulp comprising:
mixing bleached softwood pulp, sodium metaperiodate and sodium chlorite in water for a period of time, thereby producing 2,3-dialdehyde cellulose pulp (DACP).

2. The method according to claim 1 wherein the mixing is carried out under low light conditions or in the dark.

3. The method according to claim 1 wherein the sodium metaperiodate added to the softwood pulp at about 50-100 mol % periodate per mole of anhydrous glucose unit (AGU).

4. The method according to claim 1 wherein the period of time is from 0 to 7 days.

5. The method according to claim 1 wherein the mixing is carried out at a temperature between about 15 C to 60 C.

6. The method according to claim 1 wherein the produced DACP is filtered and washed with water.

7. The method according to claim 1 wherein the mixture is:
2. 5-5.0% bleached softwood pulp (w/v or w/100 ml water),
1.5-3.0% sodium metaperiodate (w/v or w/100 ml water); and
2-5% sodium chlorite (w/v or w/100 ml).

8. A method for producing 2,3-dicarboxyl cellulose pulp (DCCP) comprising:
mixing 2,3-dialdehyde cellulose pulp, sodium chlorite and hydrogen peroxide in water having a pH of 5 or below for a period of time, thereby producing DCCP.

9. The method according to claim 8 wherein the pH is maintained at below 5 by addition of a base.

10. The method according to claim 8 wherein the produced DCCP is precipitated by addition of ethanol.

11. The method according to claim 10 wherein the precipitated DCCP is filtered and washed with acetone.

12. The method according to claim 8 wherein the period of time is from 0 to 7 days.

13. The method according to claim 8 wherein the mixing is carried out at a temperature between about 15 C to 60 C.

14. The method according to claim 8 wherein the mixture is:
2-5% DACP (w/v or g/100 ml water);
0.5-1.5% sodium chlorite (w/v or g/100 ml water); and
0.5-1.5% of a 30% hydrogen peroxide solution (w/v or g/100 ml water).

15. A method for producing 2,3-dicarboxyl cellulose pulp (DCCP) comprising:
mixing bleached softwood pulp, sodium metaperiodate and sodium chlorite in water for a period of time, thereby producing 2,3-dialdehyde cellulose pulp (DACP); and
mixing the 2,3-dialdehyde cellulose pulp with sodium chlorite and hydrogen peroxide in water having a pH of 5 or below for a period of time, thereby producing DCCP.

16. The method according to claim 15 wherein the production of DACP is carried out under low light conditions and/or in the dark.

17. The method according to claim 15 wherein the sodium metaperiodate is added to the softwood pulp at about 50-100 mol % periodate per mole of anhydrous glucose unit (AGU).

18. The method according to claim 15 where the period of time of the first reaction and/or the second reaction is from 0 to 7 days.

19. The method according to claim 15 wherein the reactions are carried out at a temperature between about 15 C to 60 C respectively.

20. The method according to claim 15 wherein the produced DACP is filtered and washed with water prior to use in the second reaction.

21. The method according to claim 15 wherein the first reaction mixture is:
2.5-5.0% bleached softwood pulp (w/v or w/100 ml water),
1.5-3.0% sodium metaperiodate (w/v or w/100 ml water); and
2-5% sodium chlorite (w/v or w/100 ml).

22. The method according to claim 15 wherein the pH of the second reaction is maintained at below 5 by addition of a base.

23. The method according to claim 15 wherein the produced DCCP is precipitated by addition of ethanol.

24. The method according to claim 23 wherein the precipitated DCCP is filtered and washed with acetone.

25. The method according to claim 15 wherein the second reaction mixture is:
2-5% DACP (w/v or g/100 ml water);
0.5-1.5% sodium chlorite (w/v or g/100 ml water); and
0.5-1.5% of a 30% hydrogen peroxide solution (w/v or g/100 ml water).

26. The method according to claim 15 wherein DCCP is further reacted with a suitable amine-containing crosslinking agent.
